(19) United States
(12) Patent Application Publication
(10) Pub. No.: US 2020/0196624 A1
(43) Pub. Date: Jun. 25, 2020

(54) METHODS AND COMPOSITIONS FOR HEALTHY TONICS AND TEAS

(71) Applicant: DAILY HARVEST, INC., New York, NY (US)

(72) Inventor: Rachel Drori, New York, NY (US)

(21) Appl. No.: 16/640,579

(22) PCT Filed: Aug. 20, 2018
(86) PCT No.: PCT/US18/00347

§ 371 Date: Feb. 20, 2020

Related U.S. Application Data
(60) Provisional application No. 62/549,165, filed on Aug. 23, 2017.

(51) Int. Cl. A23F 3/16; A23F 3/34; A23L 3/36; A23F 3/14; A23L 2/38

(52) U.S. Cl. CPC A23F 3/16; A23F 3/34; A23L 2/38; A23F 3/14; A23L 3/364

(57) ABSTRACT

A frozen tea or tonic precursor composition including a mixture including at least two frozen ingredients selected from the group consisting of tea leaves, roots, herbs, fruit, flowers, vegetables, and combinations thereof, wherein each ingredient is not dried and is at least one of whole, unrefined, and unprocessed, the composition further characterized by an absence of added sugar, artificial ingredients, and artificial preservatives. The mixture defines a solid three-dimensional shape having an external surface area-to-volume ratio of at least 2/cm. A method of preparing the mixture is disclosed. A single-service container may include only one or more of the solid three-dimensional shapes.

### RELATED APPLICATION

This application claims the benefit of priority to U.S. Provisional Application Ser. No. 62/549,165 filed Aug. 23, 2017, which is incorporated herein by reference in its entirety.

### BACKGROUND

Tea through history has either been steeped fresh from the plant or preserved through a drying process and steeped later to unlock the flavor and benefits of the ingredients. Steeping tea fresh from a plant may be burdensome to the consumer. The drying process may be more convenient, but may have the drawback of a reduction in nutritional value.

### SUMMARY

Embodiments of the invention provide much of the same convenience and accessibility offered by steeping dried ingredients, by individually quick freezing tea components straight off the plant. This allows consumers to enjoy the benefits of freshly picked tea ingredients, but in a convenient and accessible format.

In an aspect, embodiments of the invention relate to a frozen tonic precursor composition including a mixture at least two frozen ingredients. The frozen ingredients may be tea leaves, roots, herbs, fruit, flowers, vegetables, and/or combinations thereof. Each ingredient is not dried and is at least one of whole, unrefined, and unprocessed. The composition is further characterized by an absence of added sugar, artificial ingredients, and artificial preservatives. The mixture of the at least two frozen ingredients defines a solid three-dimensional shape having an external surface area-to-volume ratio of at least 2/cm.

One or more of the following features may be included. The tea leaves may be black tea leaves, green tea leaves, white tea leaves, tulsi leaves, rooibos leaves, runa leaves, raspberry leaves, gingko biloba, and/or mint leaves. The roots may be licorice, ginger, taro, chicory, ginseng, beet, dandelion, maca, and/or turmeric.

The herbs may rosemary, thyme, lemongrass, shavegrass, alchemilla, ashwaganda, stinging nettle, schisandra, ho shou wu, epimedium, and/or sage.

The fruit may be berries, orange, lemon, lime, apple, cherry, mango, peach, pear, coconut, coconut cream, coconut oil, coconut meat, dates, fig, bilberry, passion fruit, dragon fruit, lucama, goji, longan, and/or pineapple.

The flowers may be chamomile, jasmine, hibiscus, echinacea, dandelion, rose petals, clover, elderberry, honeybush, stevia, salvia, and/or lavender.

The vegetables may be beets, carrots, cucumber, fennel, peas, and/or lentils.

The mixture may further include at least one additional ingredient of spices, seeds, fungi, grains, barks, botanical secretions, algae, bacteria, nuts, and/or proteins.

The spices may be black pepper, white pepper, nutmeg, turmeric, sea salt, clove, allspice, cardamom, cayenne pepper, cinnamon, willow, alder, hawthorne, maple, peppermint, slippery elm, arjuna bark, chia, sesame, hemp, carob, sicklepod, star anise, cacao, and/or poppy seed.

The fungi may be cordyceps and/or aspergillus mushrooms.

The grains may be barley, rice, brown rice, quinoa, and/or buckwheat.

The botanical secretion may be honey, maple syrup, and/or shilajit.

The algae may be spirulina, blue green algae, blue algae, and/or red algae.

The bacteria may be kombucha scobi and/or lactobacillus.

The nuts may be hazelnuts, almonds, pine nuts, walnuts, pistachio, and/or cacao.

The proteins may be pea, hemp, whey, soy, and/or egg.

The composition is a single portion disposed in a sealed, single-service container. Contents of the single-service container may include only the composition.

The composition may be prepared for consumption by addition of a liquid. The liquid may be water and/or milk. The liquid may be hot.

In another aspect, embodiments of the invention relate to a method of preparing a tonic for consumption. The method includes providing a frozen tonic precursor composition a mixture of at least two frozen ingredients. The frozen ingredients may be tea leaves, roots, herbs, fruit, flowers, vegetables, and combinations thereof, with each ingredient not being dried and being at least one of whole, unrefined, and unprocessed. The composition is further characterized by an absence of added sugar, artificial ingredients, and artificial preservatives. The mixture of the at least two frozen ingredients defines a solid three-dimensional shape having an external surface area-to-volume ratio of at least 2/cm. The frozen tonic precursor composition may be mixed with a liquid.

One or more of the following features may be included. An amount of the liquid is selected for mixing, such that a temperature change of the liquid before and 60 seconds after mixing is no more than 15%.

The liquid may include hot milk and/or hot water, having a temperature from the range 90° C. to 100° C. The liquid may include a cold liquid such as milk and/or water, a temperature of the cold liquid being selected from a range of 1° C. to 25° C.

In yet another aspect, embodiments of the invention relate to a method of preparing a frozen tonic precursor composition. The method includes providing at least two ingredients. The ingredients may be tea leaves, roots, herbs, fruit, flowers, vegetables, and combinations thereof. The ingredients may be chopped, shredded, mashed, sliced, and/or grated to form a tonic precursor composition. The tonic precursor composition may be mixed and frozen into a solid three-dimensional shape having an external surface area-to-volume ratio of at least 2/cm. Each of the at least two ingredients may not be not dried and is at least one of whole, unrefined, and unprocessed, and (ii) the frozen tonic precursor composition is further characterized by an absence of added sugar, artificial ingredients, and artificial preservatives.

In still another aspect, embodiments of the invention relate to a tea bag including a frozen tea precursor composition including a substantially loose mixture of at least two frozen ingredients. The frozen ingredients may be tea leaves, roots, herbs, fruit, flowers, spices, seeds, fungi, grains, barks, botanical secretions, algae, bacteria, nuts, vegetables, proteins, and combinations thereof. Each ingredient is not dried and is at least one of whole, unrefined, and unprocessed. The composition is further characterized by an absence of added sugar, artificial ingredients, and artificial preservatives. The mixture is disposed in a porous container, such as a tea filter bag, a mesh, or a pod.

In another aspect, embodiments of the invention relate to a food article including a sealed single-service container. A solid three-dimensional shape is disposed in the container. The shape includes only a mixture comprising at least two frozen ingredients. The solid three-dimensional shape has an external surface area-to-volume ratio of at least 2/cm. The contents of the single-service container include only the solid three-dimensional shape.

One or more of the following features may be included. The ingredients may be tea leaves, roots, herbs, fruit, flowers, vegetables, and combinations thereof. Each ingredient is not dried and is at least one of whole, unrefined, and unprocessed. The composition is further characterized by an absence of added sugar, artificial ingredients, and artificial preservatives. A plurality of the single solid three-dimensional shapes may be disposed in the container and the contents of the container may include only the plurality of solid three-dimensional shapes.

### DETAILED DESCRIPTION

As used herein, “tonic” means a drink made by infusing the leaves, roots, barks, and/or flesh of plants, spices, trees, flowers, bacteria, roots, herbs, nuts, fruits, vegetables, proteins, or combinations thereof in a liquid.

As used herein, “tea” means a drink made by infusing the leaves, roots, barks, and/or flesh of plants, spices, trees, flowers, bacteria, roots, herbs, nuts, fruits, vegetables, proteins, or combinations thereof in a liquid, the ingredients being in a loose or solid form, with at least a portion of residual solids being removed from the drink after infusion.

As used herein, “processed food” means any food that has been altered from its natural state in some way, other than frozen, either for safety reasons or convenience.

As used herein, “refined food” means a food that does not contain all of its original nutrients, i.e., not a whole food.

As used herein, “whole food” means a food that is natural, unprocessed, and unrefined.

As used herein, “artificial substance” means any substance created artificially to enhance food products. For example, artificial flavoring is a specific and often complex mixture of singular naturally occurring flavor compounds combined to either imitate or enhance a natural flavor.

As used herein, “artificial preservative” means chemical substances added to foods.

As used herein, “natural flavor” or “natural flavoring” means the essential oil, oleoresin, essence or extractive, protein hydrolysate, distillate, or any product of roasting, heating or enzymolysis, that contains the flavoring constituents derived from a spice, fruit or fruit juice, vegetable or vegetable juice, edible yeast, herb, bark, bud, root, leaf or similar plant material, meat, seafood, poultry, eggs, dairy products, or fermentation products thereof, whose significant function in food is flavoring rather than nutritional.

As used herein, a “concentrate” means a concentrated form of a foodstuff, in which the bulk is reduced by the removal of water.

As used herein, a “spice” means a seed, root, or bark primarily used for flavoring or coloring food.

As used herein, an “herb” is a leaf, flower or stem from a plant used for flavoring or as a garnish.

As used herein, “fresh” means in the same state as picked from the plant.

As used herein, “dried” means a concentrated form of a foodstuff, in which the water content is reduced as a method of preservation.

As used herein, “added sugar” means sugars added that are not in a state found in nature.

As used herein, a “natural flavor” means the essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, or leaf.

As used herein, “surface area” refers to a total area of exposed surface in a pellet formed in accordance with embodiments of the invention.

As used herein, “volume” refers to the volume of solid material in a pellet formed in accordance with embodiments of the invention.

### Frozen Tonic Precursor Compositions

Frozen tonic precursor compositions, in accordance with embodiments of the invention, include a mixture of at least two ingredients, with the ingredients not being dried prior to being frozen. Not drying the ingredient prevents the reduction of nutrient density and flavor.

The food product ingredients that may be used in the frozen blends may be whole and/or unrefined and/or unprocessed. Accordingly, maximal nutritional value and flavor is provided by each ingredient. Moreover, the compositions do not have any refined sugar, artificial ingredients, or artificial sweeteners.

The at least two ingredients may be selected from a number of categories, such as tea leaves, roots, herbs, fruit, flowers, vegetables, and combinations thereof. This selection of ingredients provides at least two advantages. First, these are generally traditional tea and tonic ingredients, and, therefore, have been proven to appeal to the tastes of consumers. In addition, the use of whole, unrefined, and/or unprocessed ingredients that are not dried, with the compositions being free of added sugar, artificial ingredients, and artificial preservatives provides health benefits.

In some embodiments, the mixture may include at least one additional ingredient selected from other categories, such as spices, seeds, fungi, grains, barks, botanical secretions, algae, bacteria, nuts, proteins, and combinations thereof.

The selection of ingredients is based upon desired flavor and nutritional value. The particular health benefits to be attained, e.g., weight loss, stress relief, etc., may be taken into account when selecting the ingredients. Moreover, traditional tea and tonic formulations popular with consumers may be used for guidance.

Suitable tea leaves are, e.g., black tea leaves, green tea leaves, white tea leaves, tulsi leaves, rooibos leaves, runa leaves, raspberry leaves, gingko biloba, and/or mint leaves.

Suitable roots are, e.g., licorice, ginger, taro, chicory, ginseng, beet, dandelion, maca, and/or turmeric.

Suitable herbs are, e.g., rosemary, thyme, lemongrass, shavegrass, alchemilla, ashwaganda, stinging nettle, schisandra, ho shou wu, epimedium, and/or sage.

Suitable fruit are, e.g., berries, orange, lemon, lime, apple, cherry, mango, peach, pear, coconut, coconut cream, coconut oil, coconut meat, dates, fig, bilberry, passion fruit, dragon fruit, lucama, goji, longan, and/or pineapple. The fruit is preferably in a form other than fruit juice.

Suitable flowers are, e.g., chamomile, jasmine, hibiscus, echinacea, dandelion, rose petals, clover, elderberry, honeybush, stevia, salvia, and/or lavender.

Suitable vegetables are, e.g., beets, carrots, cucumber, fennel, peas, and/or lentils.

Suitable spices are, e.g., black pepper, white pepper, nutmeg, turmeric, sea salt, clove, allspice, cardamom, cayenne pepper, cinnamon, willow, alder, hawthorne, maple, peppermint, slippery elm, arjuna bark, chia, sesame, hemp, carob, sicklepod, star anise, cacao, and/or poppy seed.

Suitable fungi are, e.g., cordyceps and/or aspergillus mushrooms.

Suitable grains are, e.g., barley, rice, brown rice, quinoa, and/or buckwheat.

Suitable botanical secretions are, e.g., honey, maple syrup, and/or shilajit.

Suitable algae are, e.g., spirulina, blue green algae, blue algae, and/or red algae.

Suitable bacteria are, e.g., kombucha scobi and/or lactobacillus.

Suitable nuts are, e.g., hazelnuts, almonds, pine nuts, walnuts, pistachio, and/or cacao.

Suitable proteins are, e.g., pea, hemp, whey, soy, and egg.

The mixture of ingredients is frozen to define a solid three-dimensional shape, also referred to herein as a pellet. Any appropriate shape may be formed, including a disk, a cube, a tetrahedron, a sphere, a pyramid, etc. The pellet may also be irregularly shaped. Preferably, at least one ingredient may be a binding agent having binding properties, e.g., stickiness, that helps bind the other the ingredients together in the desired shape. Suitable binding ingredients include, e.g., ginger puree, coconut milk, almond butter, and lemon juice.

In an embodiment, the pellet is a disk with a diameter that is preferably smaller than a diameter of the container in which it will be used, e.g., smaller than a diameter of an average cup, and does not cool the liquid below 135 degrees F., and big enough such that the pellet flavors the water appropriately when steeped. For example, the diameter may be selected from a range of, e.g., 0.5″ to 20″, 1″ to 6″, or 1″ to 3″, depending on the application. A thickness of the disk is selected to be thin enough for the disk to dissolve quickly and to not cool the water below 135° F. (57° C.) but also thick enough such that it can withstand packaging and is not too fragile. The thickness may be selected from a range of, e.g., 0.01″ to 20″. In some embodiments, the pellet is sized to fit into a beverage container, e.g., a disk having a diameter of about 3″ and a thickness of 0.25″.

The frozen solid three-dimensional shapes in accordance with embodiments of the invention contain at least 51 wt %, 60 wt %, 70 wt %, 80 wt %, or 90 wt % food product ingredients as described herein, that are whole and/or unrefined and/or unprocessed. This minimum weight percentage of fresh ingredients that are whole, unrefined, and/or unprocessed ensures that the frozen composition retains the benefits of the fresh ingredients. In particular, in some embodiments, the frozen shapes may additionally contain certain dried spices or peppercorns, or extracts such as mint oil, but may not contain more than 49%, 40 wt %, 30 wt %, 20 wt %, or 10 wt % of such additional constituents. In any case, the frozen shapes may not include any quantity of refined sugar, artificial flavorings, concentrates, dried leaves, or dried roots.

Examples of refined sugar are granulated white sugar and corn syrup. Examples of artificial flavorings are any of the synthetic flavoring substances listed in 21 CFR 172.515, and may include, e.g., vanilla extract bound in alcohol. An example of a natural flavor is orange flavoring. Most fruit flavors have just one or a few dominant chemical components that carry the bulk of the taste/smell signal. Many of these chemicals are called esters. For example, the ester called octyl acetate (CH3COOC8H17) is a fundamental component in orange flavor. The ester called isoamyl acetate (CH3COOC5H11) is a fundamental component of banana flavor. If these esters, i.e., artificial flavorings, are added to a product, the product will taste, to some degree, like orange or banana. An example of a concentrate is, e.g., fruit juice concentrate. Examples of dried leaves are dried black tea leaves. Examples of dried roots are powdered ginger or turmeric.

### Method of Making Frozen Solid Three-Dimensional Shapes for Tonic Precursor Compositions

The frozen shapes or pellets described herein may be individually quick frozen (“IQF”). In particular, they may be formed by first creating a uniform mixture of ingredients by mixing the desired ingredients and then granulating the ingredients by, e.g., chopping, shredding, mashing, slicing, and/or grating. In some embodiments, the ingredients may be granulated before mixing. The uniform mixture is fed through an IQF pelletizer, e.g., a CRYOGRAN system from IQF Inc., based in Ontario, Canada. The IQF pelletizer delivers frozen shapes of the desired ingredients for tonics in accordance with an embodiment of the invention.

Alternatively, the uniform mixture may be placed into the cavities of a mold. The mold may be made from a suitable non-stick material, such as stainless steel coated with polytetrafluoroethylene (PTFE). Alternatively, the molds may be flexible, such as those made with silicone. The cavities of the mold have a desired shape and size for defining the pellets, i.e., sized to make a frozen shape or disk with the desired dimensions. For example, to form a disc-shaped pellet having a diameter of 3″ and a height of 0.25″, the mold may have cavities with a diameter of 3″ and a height of 0.25″. The uniform mixture may then be frozen in the mold to define the pellets, and subsequently removed from the mold. The uniform mixture may be frozen at any temperature below 32° F., such as −150° F. or lower, e.g., −180° F. to −200° F.

The frozen tonic precursor composition may be packaged as a single portion in a sealed, single-service container. A suitable container is a 16 ounce cardboard cup, although any other beverage container size may be used, such as 4 ounce, 8 ounce, 12 ounce, 20 ounce, 24 ounce, etc. In some embodiments, the frozen tea precursor composition may be packaged in individual serving-sized plastic sleeves, with a plurality of sleeves packaged in a cardboard box, analogous to the way in which teabags are packaged.

Preferably, when packaged, the frozen tonic precursor composition includes only the solid three-dimensional shape, which contains all of the ingredients of the tonic other than the liquid that is to be added to the pellet to prepare the tonic. In other words, in some embodiments, no ingredients in addition to the pellet are packaged in the container. This provides the advantage of convenience and single serving, as well as simplifying the packaging.

In some embodiments, two or more pellets, with no ingredients in addition to the pellets, may be included in the container. This may help increase the surface area to volume ratio, thereby increasing at which the pellet contents dissolve in liquid, without substantially changing the temperature of the added liquid.

### Method of Using Frozen Tonic Precursor Compositions

In use, the frozen pellets are dissolved by a boiling liquid, such as boiling water or milk, to form a beverage. In some embodiments, the beverage is hot, i.e., close to a boiling point of 212° F. (100° C.), e.g., between 170-212° F. (77-100° C.) immediately after a pellet has been added, and between 135-170° F. (57-77° C.) after the pellet has been dissolved in the hot liquid.

Accordingly, the frozen pellet preferably has a sufficiently high surface area to volume ratio, to enable the beverage to remain hot after contact with the frozen pellet. For example, a preferred surface area to volume ratio of a frozen pellet may be at least 2/cm (5/in).

In an embodiment, the temperature of a hot liquid into which the pellet dissolves may change by no more than 15%, e.g., no more than 15° C. or 27° F. 60 seconds after 8 ounces of liquid is added to the pellet. In an embodiment, to make a 16 ounce cup of tonic, a frozen pellet may be shaped as a disk having a diameter of 3″ and a thickness of 0.25″; these dimensions may vary, depending on the ingredients and amount of liquid added to produce a drink in an amount desired.

In another embodiment, for use with a 16 ounce container, the frozen pellet may be shaped as a square having sides of 5 cm×5 cm, with a thickness less than 1 cm, e.g., 0.5 cm or 0.75 cm. The corresponding surface area and volume are as follows:

Square pellet

| | | | | | | Initial | | |
|---|---|---|---|---|---|---|---|---|
| 1^{st} | 2^{nd} | | | | | temperature | Temperature of | |
| side | side | Height | Volume | Surface Area | Surface Area/ | of 8 oz. of | liquid after | Δ |
| (l) | (w) | (h) | (lwh) | 2lw + 2lh + 2wh | Volume ratio | hot liquid | 60 seconds | temp. |
| 5 cm | 5 cm | 1 cm | 25 cm³ | 70 cm² | 2.8/cm | 173 | 131 | 42 |
| 5 cm | 5 cm | 0.75 cm | 18.75 cm³ | 65 cm² | 3.5/cm | 182 | 139 | 43 |
| 5 cm | 5 cm | 0.5 cm | 12.5 cm³ | 60 cm² | 4.8/cm | 175 | 152 | 23 |

Experiments were conducted with frozen pellets of a mixture of frozen fruits, vegetables, and tea, i.e., pineapple, coconut, kale, matcha, lime, and vanilla). For the given composition, a surface area to volume ratio of 2.8/cm or 3.5/cm was too low with the indicated dimensions, resulting in a temperature change of about 43° F. (about 24%) 60 seconds after 8 ounces of a hot liquid was applied to the pellet. A surface area to volume ratio of 4.8/cm provided acceptable results, i.e., a temperature change of about 23° F. 60 seconds after a hot liquid was added to the pellet. For some compositions and/or amount of added liquid, a lower surface area to volume ratio is acceptable, e.g., a ratio of 2/cm.

In the above example the surface area and volume are calculated without taking into consideration any irregularities in the smoothness of the external surface of the square pellet, as well as any random voids in the pellet. In practice, external surface roughness increases the external surface area, as does any bore formed through a pellet. Similarly, voids and bores in the pellet may decrease the volume of material present in the pellet. Accordingly, empirical results may facilitate optimization of the external surface area to volume ratio for achieving an acceptable liquid temperature change for a given composition, as well as the time period needed for pellet to dissolve.

In some embodiments, the frozen pellets are mixed with cold liquid, such as milk or water, to form a beverage, with the temperature of the liquid being less than 100 degrees Celsius, preferably within a range of 1° to 25° C., e.g., 1° to 10° C. For example, cold water may be poured over the frozen pellet to fill the container, e.g., to fill a 16 ounce container. The pellet and water may be allowed to sit overnight at room temperature or under refrigeration (e.g., 5° C.) such that the pellet dissolves, forming a tonic of infused water. Alternatively, a blender, manual shaking, manual stirring, etc. may be used to accelerate the dissolving of the pellet in the water.

### Teas

The frozen ingredients described herein may be provided in a loose form encased in a container, such as a tea filter bag, mesh, or pod, so that the ingredients may be steeped in a liquid without the body of the ingredients being consumed.

A traditional tea bagging machine, e.g., a Mod C3# tea pod packaging machine from OMAG Srl, Gradara, Italy, or a ZENOBIA system, available from Teepack, Meerbusch, Germany, retrofitted to work in a frozen atmosphere environment may be used to encase the frozen ingredients.

In an embodiment, to make a 16 ounce cup of tea, a suitable teabag may be disk-shaped with a diameter of about 3″ and a thickness of about 0.25″. The size of the teabag may vary based on the ingredients and proportionally altered based on the desired amount of liquid to be used with the teabag.

### Exemplary Parameters

Exemplary parameters related to disc-shaped pellets of teas and tonics, in accordance with embodiments of the invention, are included in the table below:

| | Min. | Nominal | Max. | |
|---|---|---|---|---|
| Parameter | value | value | value | (units) |
| Pellet diameter (d or | 0.5 | 3 | 6 | inches |
| 2r) (disc-shaped) | | | | |
| Pellet thickness (h) | 0.01 | 0.25 | 2 | inches |
| (disc-shaped) | | | | |
| Pellet volume (disc- | 0.002 | 1.8 | 54 | cubic inches |
| shaped) [πr²h] | | | | |
| Pellet surface area to | 5 | 9.3 | 10,000 | /inch |
| volume ratio (disc- | | | | |
| shaped) | | | | |
| [surface area = 2πrh + | | | | |
| 2πr² | | | | |
| [volume = πr²h] | | | | |
| [sa/vol = 2(r + h)/(r*h)] | | | | |
| Pellet surface area to | 2 | 3.7 | 3900 | /cm |
| volume ratio (disc- | | | | |
| shaped) (inches | | | | |
| converted to cm) | | | | |

### EXAMPLES

Some specific examples of the preparation of frozen pellets, as well as preparation of beverages from the pellets, are given below.

Lattes/Tonics
1. Mix together fresh herbs, roots, and other ingredients. An exemplary composition is:
   1 oz. ginger puree
   1 oz. turmeric puree
   0.05 oz. ginger, ground
   0.1 oz. cinnamon powder
   0.05 oz. cardamom, ground
   0.1 oz. pepper, white, ground
   0.01 oz. coriander, ground
2. Granulate the mixed fresh ingredients by grating.
3. Without drying, freeze at least a portion of the grated mixed fresh ingredients to form a solid frozen cube, the cube having an appropriate surface area for dissolving in a cup of boiling liquid without making the liquid cold. The composition may be packaged in, e.g., a 16 oz. container.

To consume, place the solid frozen cube in a cup and pour hot or boiling milk on top to create an instant latte (or hot or boiling water to create an instant tonic) using fresh, unrefined, whole food ingredients. Alternatively, the hot or boiling liquid may be added directly to the container in which the composition is packaged, e.g., sufficient to fill a 16 oz. container.

Teas
1. Mix together fresh tea leaves, herbs, fruits, roots, and other ingredients. An exemplary composition is:
   0.25 oz. mint leaves
   0.25 oz. licorice root
   0.1 oz. shavegrass
   0.05 oz. lemon balm leaves
2. Granulate the mixed fresh ingredients by chopping.
3. Without drying, freeze at least a portion of the chopped mixed fresh ingredients.
4. Encase the frozen portion of loose mixed fresh ingredients in a disposable tea bag.
   To consume, place the tea bag in a cup and pour hot or boiling water on top. Allow water and tea bag to steep, to create a fresh tea using fresh, unrefined, whole food ingredients.

Tea—Alternative Form
1. Mix together fresh tea leaves, herbs, fruits, roots, and other ingredients. An exemplary composition is:
   0.25 oz. mint leaves
   0.25 oz. licorice root
   0.1 oz. shavegrass
   0.05 oz. lemon balm leaves
2. Granulate the mixed fresh ingredients by chopping.
3. Without drying, freeze at least a portion of the chopped mixed fresh ingredients to form a solid frozen shape, the solid shape having an appropriate surface area for dissolving in a cup of boiling liquid without making the liquid cold.

To consume, place frozen cube in a cup and pour boiling water on top. Alternatively, place frozen cube into a tea steeping colander, place the cube and colander in a cup, and pour boiling water on top. Allow water and dissolved cube to steep, to create a fresh tonic using fresh, unrefined, whole food ingredients.

Cooler
1. Mix together fresh tea leaves, herbs, fruits, vegetables, roots, and other ingredients. An exemplary composition is:
   0.5 oz. ginger
   1 oz. cucumber
   0.5 oz. fennel seed
   0.5 oz. pink peppercorn
   0.5 oz. raspberry
2. Granulate the mixed fresh ingredients by chopping.
3. Without drying, freeze at least a portion of the chopped mixed ingredients to form a solid frozen cube.

To consume, place cube in a cup and pour water on top. Allow the cube to melt, integrate with the water, and infuse with water to create a fresh tonic using fresh, unrefined, whole food ingredients.

While several aspects of the present invention have been described and depicted herein, alternative aspects may be effected by those skilled in the art to accomplish the same objectives. Accordingly, it is intended that the appended claims cover all such alternative aspects as fall within the true spirit and scope of the invention.

What is claimed is:

1. A frozen tonic precursor composition comprising:
a mixture comprising at least two frozen ingredients selected from the group consisting of tea leaves, roots, herbs, fruit, flowers, vegetables, and combinations thereof, wherein each ingredient is not dried and is at least one of whole, unrefined, and unprocessed, the composition further characterized by an absence of added sugar, artificial ingredients, and artificial preservatives,
wherein the mixture of the at least two frozen ingredients defines a solid three-dimensional shape having an external surface area-to-volume ratio of at least 2/cm.

2. The composition of claim 1, wherein the tea leaves are selected from the group consisting of black tea leaves, green tea leaves, white tea leaves, tulsi leaves, rooibos leaves, runa leaves, raspberry leaves, gingko biloba, and mint leaves.

3. The composition of claim 1, wherein the roots are selected from the group consisting of licorice, ginger, taro, chicory, ginseng, beet, dandelion, maca, and turmeric.

4. The composition of claim 1, wherein the herbs are selected from the group consisting of rosemary, thyme, lemongrass, shavegrass, alchemilla, ashwaganda, stinging nettle, schisandra, ho shou wu, epimedium, and sage.

5. The composition of claim 1, wherein the fruit are selected from the group consisting of berries, orange, lemon, lime, apple, cherry, mango, peach, pear, coconut, coconut cream, coconut oil, coconut meat, dates, fig, bilberry, passion fruit, dragon fruit, lucama, goji, longan, and pineapple.

6. The composition of claim 1, wherein the flowers are selected from the group consisting of chamomile, jasmine, hibiscus, echinacea, dandelion, rose petals, clover, elderberry, honeybush, stevia, salvia, and lavender.

7. The composition of claim 1, wherein the vegetables are selected from the group consisting of beets, carrots, cucumber, fennel, peas, and lentils.

8. The composition of claim 1, wherein the mixture further comprises at least one additional ingredient selected from the group consisting of spices, seeds, fungi, grains, barks, botanical secretions, algae, bacteria, nuts, and proteins.

9. The composition of claim 8, wherein the spices are selected from the group consisting of black pepper, white pepper, nutmeg, turmeric, sea salt, clove, allspice, cardamom, cayenne pepper, cinnamon, willow, alder, hawthorne, maple, peppermint, slippery elm, arjuna bark, chia, sesame, hemp, carob, sicklepod, star anise, cacao, and poppy seed.

10. The composition of claim 8, wherein the fungi are selected from the group consisting of cordyceps and aspergillus mushrooms.

11. The composition of claim 8, wherein the grains are selected from the group consisting of barley, rice, brown rice, quinoa, and buckwheat.

12. The composition of claim 8, wherein the botanical secretion is selected from the group consisting of honey, maple syrup, and shilajit.

13. The composition of claim 8, wherein the algae are selected from the group consisting of spirulina, blue green algae, blue algae, and red algae.

14. The composition of claim 8, wherein the bacteria are selected from the group consisting of kombucha scobi and lactobacillus.

15. The composition of claim 8, wherein the nuts are selected from the group consisting of hazelnuts, almonds, pine nuts, walnuts, pistachio, and cacao.

16. The composition of claim 8, wherein the proteins are selected from the group consisting of pea, hemp, whey, soy, and egg.

17. The composition of claim 1, wherein the composition is a single portion disposed in a sealed, single-service container.

18. The composition of claim 17, wherein contents of the single-service container consist essentially of the composition.

19. The composition of claim 1, wherein the composition is prepared for consumption by addition of a liquid.

20. The composition of claim 19, wherein the liquid comprises at least one of water and milk.

21. The composition of claim 19, wherein the liquid is a hot liquid.

22. A method of preparing a tonic for consumption, the method comprising the steps of:
providing a frozen tonic precursor composition comprising:
a mixture comprising at least two frozen ingredients selected from the group consisting of tea leaves, roots, herbs, fruit, flowers, vegetables, and combinations thereof, wherein each ingredient is not dried and is at least one of whole, unrefined, and unprocessed, the composition further characterized by an absence of added sugar, artificial ingredients, and artificial preservatives,
wherein the mixture of the at least two frozen ingredients defines a solid three-dimensional shape having an external surface area-to-volume ratio of at least 2/cm; and
mixing the frozen tonic precursor composition with a liquid.

23. The method of claim 22, wherein an amount of the liquid is selected for mixing, such that a temperature change of the liquid before and 60 seconds after mixing is no more than 15%.

24. The method of claim 22, wherein the liquid comprises a hot liquid selected from the group consisting of hot milk and hot water, having a temperature selected from the range 90° C. to 100° C.

25. The method of claim 22, wherein the liquid comprises a cold liquid selected from the group consisting of milk and water, a temperature of the cold liquid being selected from a range of 1° C. to 25° C.

26. A method of preparing a frozen tonic precursor composition, the method comprising the steps of:
providing at least two ingredients selected from the group consisting of tea leaves, roots, herbs, fruit, flowers, vegetables, and combinations thereof;
at least one of chopping, shredding, mashing, slicing, and grating the provided ingredients to form a tonic precursor composition; and
mixing and freezing the tonic precursor composition into a solid three-dimensional shape having an external surface area-to-volume ratio of at least 2/cm,
wherein each of the at least two ingredients is not dried and is at least one of whole, unrefined, and unprocessed, and (ii) the frozen tonic precursor composition is further characterized by an absence of added sugar, artificial ingredients, and artificial preservatives.

27. A tea bag comprising:
a frozen tea precursor composition comprising a substantially loose mixture of at least two frozen ingredients selected from the group consisting of tea leaves, roots, herbs, fruit, flowers, spices, seeds, fungi, grains, barks, botanical secretions, algae, bacteria, nuts, vegetables, proteins, and combinations thereof, wherein each ingredient is not dried and is at least one of whole, unrefined, and unprocessed, the composition further characterized by an absence of added sugar, artificial ingredients, and artificial preservatives; and
a porous container,
wherein the mixture is disposed in the porous container.

28. The tea bag of claim 27, wherein the porous container is selected from the group consisting of a tea filter bag, a mesh, and a pod.

29. A food article comprising:
a sealed single-service container; and
disposed within the container, a solid three-dimensional shape consisting essentially of a mixture comprising at least two frozen ingredients, wherein the solid three-dimensional shape has an external surface area-to-volume ratio of at least 2/cm,
wherein contents of the single-service container consist essentially of the solid three-dimensional shape.

30. The food article of claim 29, wherein the at least two frozen ingredients are selected from the group consisting of tea leaves, roots, herbs, fruit, flowers, vegetables, and combinations thereof, wherein each ingredient is not dried and is at least one of whole, unrefined, and unprocessed, the composition further characterized by an absence of added sugar, artificial ingredients, and artificial preservatives.

31. The food article of claim 29, wherein a plurality of the single solid three-dimensional shapes is disposed in the container and the contents of the container consist essentially of the plurality of solid three-dimensional shapes.
